(19) United States
(12) Patent Application Publication
(10) Pub. No.: US 2004/0035117 A1
(43) Pub. Date: Feb. 26, 2004

(54) Method and system power production and assemblies for retroactive mounting in a system for power production

(76) Inventor: Per Rosen, Lund (SE)

Correspondence Address: HARNESS, DICKEY & PIERCE, P.L.C., P.O.BOX 8910, RESTON, VA, 20195, US

(21) Appl. No.: 10/332,531

(22) PCT Filed: Jul. 10, 2001
(86) PCT No.: PCT/SE01/01603

(30) Foreign Application Priority Data
Jul. 10, 2000 (SE) 0002596-5

(51) Int. Cl. F02C 7/10

(52) U.S. Cl. 60/772; 60/39.511

(57) ABSTRACT

In a method which, owing to improved environmental properties, allows production of power, power and thermal energy, power and cold, or power, thermal energy and cold, a system includes a compression unit is used for pressurizing a working fluid containing oxygen, preferably air. The system further comprises a combustion unit which downstream of the compressing unit, as seen in the direction of flow of the working fluid, is arranged to supply a first amount of heat to the working fluid by substantially complete combustion of a fuel in the working fluid. An expansion unit is arranged to produce mechanical work during expansion of the working fluid. A heat recovery unit is arranged downstream of the expansion unit to divert a second amount of heat from the working fluid at a pressure above atmospheric pressure. The production of cold is made possible by further expansion of the working fluid in a subsequent, secondary expansion unit, by which the temperature of the working fluid can be made to be significantly below the ambient temperature. Assemblies are also provided for retroactive mounting in existing systems for power production including a gas turbine or an internal combustion engine.

### FIELD OF THE INVENTION

The present invention relates generally to power production in open systems with substantially complete combustion of fuel. More specifically, the invention concerns a method and a system for such power production, and assemblies for retroactive mounting in existing systems for power production.

### BACKGROUND ART

In open systems, the power production usually takes place in a topping cycle by pressurizing a working fluid containing oxygen, typically air, and then supplying a first amount of heat to the working fluid by substantially complete combustion of a fuel therein. The working fluid, i.e. the flue gases generated during combustion, is then allowed to expand for production of mechanical work, i.e. power.

Prior art includes many solutions for production of power in open systems. Combined power and heating plants, which produce both power and thermal energy, work with a topping cycle as described above for production of power, for example in a gas turbine or an internal combustion engine. After the topping cycle, the expanded flue gases contain residual thermal energy, so-called ‘residual heat’, which is at least partially diverted from the flue gases either for transfer to a bottoming cycle via a waste heat boiler (so-called ‘external heat recovery’), or for recirculation to the topping cycle (so-called ‘internal heat recovery’). Alternatively, the residual heat is used directly via a waste heat boiler for production of useful thermal energy and/or steam.

An example of processes working with external heat recovery is the ‘combined cycle’, whose topping cycle is typically carried out in a gas turbine which transfers the residual heat to a bottoming cycle in the form of a Rankine cycle or a Kalina cycle. From the bottoming cycle both additional power and useful thermal energy can then be produced if so desired.

Internal heat recovery is used, for example, in the so-called ‘recuperative gas turbine cycle’, the STIG cycle, the Cheng cycle as well as in humidified cycles such as HAT (Humid Air Turbine) or HAM (Humid Air Motor), which can also be used to improve the power yield per fuel unit charged, as is known, for example, from Swedish Patent 9400652-5.

Common to all these power processes is that they provide a relatively low degree of utilisation of fuel, typically about 90% based on the lower calorific value of the fuel. To achieve maximum power production essentially all thermal energy must be diverted by cooling at a temperature slightly above the ambient condition of the plant. A high power yield level is thus obtained, but with the consequence that the production of useful thermal energy ceases. This means that the degree of utilisation of fuel decreases from about 90% to about 55% while the power production yield increases from about 30-45% up to about 55%. In these types of combustion plants, the degree of utilisation of fuel could be increased by making use of even small temperature differences above the ambient condition. However, this is fairly difficult and, in many cases, simply not possible.

Another problem arises when the flue gases are to be purified from environmentally harmful pollutants, for example by means of a scrubber or a catalyst, since the purification activities result in reduced power production and sometimes also in a lower degree of utilisation of fuel, inter alia because the pressure drop in the process increases as does the need for auxiliary power. Moreover, equipment for environmental improvement for combustion plants of the above type requires considerable investments and entails fairly high variable costs.

Furthermore, the HAT and HAM techniques mentioned above are associated with a high water consumption for humidification of the working fluid before combustion, which is something that may be a problem in certain applications and/or in certain parts of the world. The HAM technique, in which a liquid is supplied to the working fluid for humidification of the working fluid after it has been pressurized but before it is burnt in an internal combustion engine, also has the disadvantage, at least in connection with retroactive mounting on existing turbosupercharged internal combustion engines, of the turbine of the internal combustion engine receiving a larger flow of flue gases than what it has been dimensioned for, which means that part of these flue gases has to be conveyed past the turbine to the surroundings resulting in a loss of mechanical work.

Further examples of prior art are WO 96/31735, EP-A2-0,982,476, GB 2,311,824, U.S. Pat. No. 4,426,842, U.S. Pat. No. 4,271,665 and U.S. Pat. No. 3,962,864.

Prior art also includes heat production technology. In the field of pressurized combustion, clean boilers have been designed, for example, which produce heat with a very high degree of utilisation of fuel. However, these boilers are not used for power production.

Accordingly, there is a need for improved power production technology.

### SUMMARY OF THE INVENTION

An object of the present invention is to overcome completely or at least partially the above described problems associated with prior art. More specifically, the purpose of the invention is to provide a simple technique for achieving improved environmental properties in power production in an open system with substantially complete combustion of fuel. The improved environmental properties include cleaner flue gases and/or a higher degree of utilisation of fuel.

According to the invention, these and other objects, which will be apparent from the following description, have been achieved by a method and a system for power production, and assemblies for retroactive mounting in existing systems, according to the independent claims. Preferred embodiments of the invention are defined in the dependent claims.

The invention is based on the basic understanding that, once a first amount of heat has been supplied to the working fluid by the combustion and said working fluid has been allowed to expand for production of mechanical work, a second amount of heat should be diverted from the expanded working fluid at a pressure above atmospheric pressure, and this should then be followed by further expansion of the working fluid. According to the invention, the expansion of the working fluid, i.e. the flue gas, is thus temporarily interrupted in an open system for power production. This allows a very high degree of utilisation of fuel, for the following reasons.

The method and system according to the invention can be used for production of power only, or power and thermal energy, or power and cold, or power, thermal energy and cold. The production of cold is made possible by the further expansion of the working fluid, preferably to atmospheric pressure, following directly after the diversion of the second amount of heat. This further expansion also allows production of additional mechanical work. Following the further expansion, the temperature of the working fluid, in a suitable state of the working fluid after diversion of the second amount of heat, will be significantly below the ambient temperature. Such a suitable state may, for example, be achieved by the second amount of heat being transferred at least partially to a district-heating system in connection with the diversion. The fact that the temperature of the working fluid after the further expansion is below the ambient temperature means that the working fluid can be caused to absorb a third amount of heat from a cooling fluid, which is thus cooled. The cooling fluid can then perform useful cooling work, for example in air-conditioning plants, cold-storage rooms, freezers, snow cannons, ice-skating rinks, etc. It will be appreciated that the technique according to the invention allows a very high degree of utilisation of fuel, typically more than 120%, if the cold produced is considered a useful quantity.

In this context, it should also be noted that all refrigerating machines in operation today consume power and/or thermal energy for the production of cold. It is true that in heat pumps, the thermal energy produced at the warm side of the pump may, in some cases, be utilised while the cold produced on the cold side of the pump at the same time is used for cooling purposes. However, some form of high-grade driving power must always be supplied to operate the heat pump. When producing cold with a heat pump it is therefore essentially impossible, unlike the method and system according to the present invention, to influence the environmental performance of processes that have generated the high-grade power.

A further advantage of the method and system according to the invention is that the working fluid can be caused to form a condensate in connection with the diversion of the second amount of heat. The fact is that in many cases, for example when burning fuels containing hydrogen and/or moisture, the flue gases contain water vapour. By diverting the second amount of heat at a pressure above atmospheric pressure, the phase transformation energy can be recovered from the flue gases to a considerably larger extent than what is possible with existing technology since the dew point is raised at a higher total pressure. By diverting the condensate from the working fluid via a purification device the purified condensate, typically water, can also be used for a variety of purposes. This is particularly advantageous in regions where water is in short supply.

Furthermore, the technology according to the invention allows a more compact design of the heat recovery unit diverting the second amount of heat from the working fluid than what is possible in power production according to prior art owing to the fact that the pressure of the working fluid is increased, i.e. above atmospheric pressure. In some known plants, for example stationary gas turbines, it is not desirable to obtain a high expansion efficiency in the expansion unit generating the mechanical work after combustion, since the temperature of the working fluid after the expansion then tends to get so low that it becomes difficult to divert the second amount of heat. With the technology according to the invention, there is no need to reduce the expansion efficiency in order to increase the temperature of the working fluid after expansion, and the expansion unit can thus be so manufactured that maximum efficiency is ensured.

It should also be pointed out that the pressure during diversion of the second amount of heat is suitably considerably higher than the ambient pressure, typically at least about 50 kPa and preferably at least about 100 kPa above atmospheric pressure. In prior-art power production systems as described above, however, the working fluid is expanded to atmospheric pressure before the second amount of heat is diverted from it. Certainly, minimal deviations from atmospheric pressure, typically about 1-5 kPa, may occur in these known systems as a result of the possible flow resistance generated by components arranged downstream. These deviations are so small, however, that the second amount of heat can be considered to be diverted from the working fluid at atmospheric pressure.

According to a preferred embodiment, the heat recovery unit diverting the second amount of heat from the working fluid comprises a scrubber. When the working fluid passes through this scrubber, diversion of at least part of the second amount of heat from the working fluid is achieved as well as purification of the working fluid, typically with regard to water-soluble pollutants therein. In addition, the scrubber, which is a robust and reliable component, can be given a compact design since it operates at a pressure above atmospheric pressure.

According to a preferred embodiment a liquid, preferably water, is introduced into the working fluid before the first amount of heat is supplied to it by the combustion. The amount of NOₓ formed during combustion can thereby be reduced, owing to a reduced combustion temperature while at the same time the degree of utilisation of fuel is increased, inter alia by reducing the temperature of the working fluid and increasing the flow through the system. It is here preferred that part of the working fluid forms a condensate in connection with the diversion of the second amount of heat. In this way, one of the disadvantages of the HAM technique stated by way of introduction, particularly in retroactive mounting on a turbosupercharged internal,combustion engine, is overcome, namely that the turbine of the internal combustion engine receives a larger flow of flue gases than it was dimensioned for. Due to the fact that part of the flue gases is condensed, and diverted, the flow of flue gases can be maintained at such a level that the need to convey flue gases past the turbine is reduced. It is also preferred that the condensate is at least partially recirculated to the working fluid before said fluid is allowed to expand for production of mechanical work. In this way, the second of the above described disadvantages of the HAT and HAM techniques, i.e. the large consumption of liquid, is overcome. The invention thus provides a closed liquid cycle, which may be advantageous in certain applications and/or in some parts of the world. Preferably, the condensate is diverted from the working fluid via a purification device. This allows water-soluble pollutants, such as sulphur, dust, heavy metals, etc. to be removed from the condensate.

The condensate is suitably heated before being recirculated to the working fluid, preferably at least partially by causing the condensate to absorb part of the second amount of heat. As a result, the energy yield can be increased.

According to another preferred embodiment, the relative distribution between the amount of mechanical work produced, the second amount of heat and, where appropriate, the third amount of heat is controlled by controlling the volume of the second amount of heat and/or said pressure. It is thus possible to adapt the method and system according to the invention to the power, thermal energy and cold requirements of the connected users. The control can be carried out either dynamically during operation or when designing the system. Dynamic control of the second amount of heat can be carried out by controlling the fluid flow on the cold side of a heat exchanger included in the heat recovery unit. The pressure in the heat recovery unit can be controlled via a control valve arranged in the system and passed by the working fluid or by braking the system's secondary expansion unit. In dynamic control, the system suitably comprises a control unit which is arranged to control one or more actuators, for example valves, in the system. If control provisions are made when designing the system, it is possible to vary the second amount of heat and/or the pressure in other ways, as will be appreciated by the person skilled in the art.

It is also possible to control the discharge temperature of the flue gases in such manner that the system does not leave any temperature trace through the flue gases, which may be of interest in certain applications.

As stated above it is possible, within the scope of the invention, to create a system for power production according to the invention, with the associated advantages, by installing an assembly for retroactive mounting in an existing internal combustion engine or gas turbine.

### BRIEF DESCRIPTION OF THE DRAWINGS

The invention will be described below by way of example, with reference to the accompanying drawings, which illustrate preferred embodiments.

FIG. 1a illustrates a general schematic diagram for a system for power production built around a gas turbine and aims at giving an overall picture of different embodiments of the present invention, and FIG. 1b illustrates a state diagram of temperature (T), entropy (s) and pressure (p) of the working fluid in the system according to FIG. 1a.

FIG. 2a illustrates a schematic diagram for another embodiment of the system according to the invention, built around a gas turbine, and FIG. 2b illustrates a state diagram of temperature (T), entropy (s) and pressure (p) of the working fluid in the system according to FIG. 2a.

FIGS. 3-5 illustrate schematic diagrams for further embodiments of the system according to the invention, each built around a gas turbine.

FIGS. 6-9 illustrate schematic diagrams of further embodiments of the system according to the invention, each built around an internal combustion engine.

### DESCRIPTION OF PREFERRED EMBODIMENTS

The same reference numerals are used in all figures to indicate equivalent components.

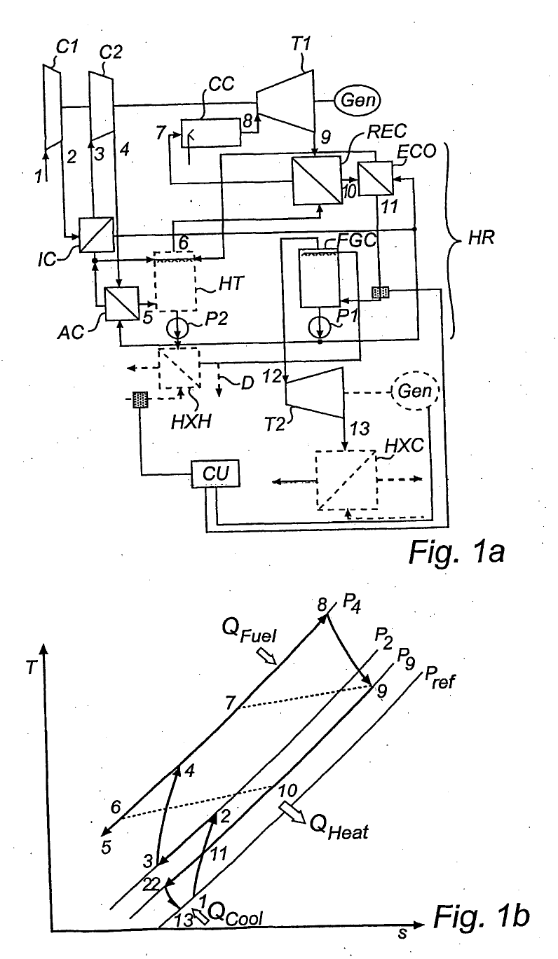

Below the basic principles of the invention will be illustrated with reference to FIGS. 1a-1b, which show a schematic diagram and a state diagram (T-s), respectively, for a system for power production built around a gas turbine. The system according to FIG. 1a comprises on the one hand a gas cycle, in which a working fluid flows for generation of power, thermal energy and cold and, on the other hand, a liquid cycle, in which water flows between different units incorporated in the system. In the schematic diagram in FIG. 1a, as in the other, subsequent schematic diagrams, the gas cycle is indicated by means of thick arrows and the liquid cycle by means of thin arrows. The states in different positions along the gas cycle in FIG. 1a are indicated by means of reference numerals 1-13, and the corresponding states are referred to by the same numerals in the state diagram in FIG. 1b, said diagram indicating the temperature (T), entropy (s) and pressure (p) of the working fluid.

The gas cycle comprises, as seen in the direction of flow of the working fluid in FIG. 1a, a first compressor C1, an intermediate cooler IC, a second compressor C2, an after-cooler AC, a humidification unit HT, a recuperator REC, a combustion chamber CC, a first turbine T1, an economiser ECO, a flue gas condenser FGC, a second turbine T2 and a heat exchanger HXC.

When operating the system according to FIG. 1a, the following changes in the state of the working fluid take place, as illustrated also in FIG. 1b.

The working fluid, which is a gas containing oxygen, typically air, is compressed polytropically in the first compressor C1 from state 1 to state 2, whereby the pressure of the working fluid is increased from atmospheric pressure p_{ref} to a raised pressure p₂. The working fluid is then cooled isobarically in the intermediate cooler IC from state 2 to state 3, after which the working fluid is compressed polytropically in the second compressor C2 from state 3 to state 4, whereby the pressure of the working fluid is further increased from pressure p₂ to pressure p₄. The compressed working fluid is then cooled isobarically from state 4 to state 5 in the after-cooler AC, after which water vapour is supplied to the working fluid under isobaric conditions in the humidification unit HT, here a humidification tower of counterflow type, with both mass and energy transport from state 5 to state 6. For the sake of completeness, it should be noted that the T-s diagram in FIG. 1b here no longer illustrates the process in a completely correct manner, since large quantities of water is supplied to the working fluid. The T-s diagram is valid only if the working fluid is not changed to any considerable extent in terms of either composition or mass flow as it passes through the cycle. After the humidification, a isobaric heat recovery takes place from state 6 to state 7 in the recuperator REC. In the subsequent combustion chamber CC, energy (Q_{fuel}) is supplied to the working fluid isobarically from state 7 to state 8 by the release of chemically bound energy in a fuel, more specifically by substantially complete combustion of the fuel in the working fluid. Having passed the combustion chamber CC the working fluid consists of hot flue gases (typically containing products of combustion, supplied water vapour and possibly excess air). Once the energy has been supplied to the combustion chamber CC, the working fluid is expanded polytropically in the turbine T1 from state 8 to state 9, i.e. down to a pressure. p₉ above ambient pressure p_{ref}. Although this is not apparent from the drawing, the expansion may, of course, take place in several steps, as is well known in gas turbine plants. During the expansion mechanical work is generated, which depending on the application can be converted into useful shaft power, for example for propulsion, or electric energy by means of a generator or the like. After expansion the working fluid is cooled isobarically from state 9 to state 10 in the recuperator REC, and the thermal energy thus diverted is transferred to the working fluid between the humidification unit HT and the combustion chamber. CC (internal heat recovery). This change of state is then followed by additional isobaric cooling of the working fluid from state 10 to state 11 in the economiser ECO. Then isobaric cooling of the working fluid from state 11 to state 12 takes place in the flue gas condenser FGC and the amount of heat thus diverted is transferred via the liquid cycle to an external heat sink, for example a district heating system, for production of useful thermal energy. In the example shown, the flue gas condenser FGC is a scrubber which is able to cool the working fluid, and thus condense part of it, and at the same time purify it from any water-soluble pollutants and dust. Because cooling from state 11 to state 12 takes place at the elevated pressure pg, the dew point of the humidity in the working fluid will also be raised. This makes it possible to eliminate almost all the humidity present in the working fluid by means of condensation at such a temperature level that the phase transformation energy thus released can be utilised, for example in a district heating system. This means that the system's degree of utilisation of fuel can be considerably improved compared to that of conventional systems.

Following this isobaric cooling a polytropic expansion of the working fluid from state 12 to state 13 takes place in the second turbine T2, for production of additional mechanical work which, depending on the application, can be converted into useful shaft power, for example for propulsion, or electric power by means of a generator or the like. Normally said fluid is expanded to atmospheric pressure p_{ref}. If access to a normal heat sink is provided for the reception of the thermal energy diverted between state 11 and state 12, for example a district-heating system at a temperature of about 45-55° C., the expansion from state 12 to state 13 can be terminated in such manner that the working fluid has a lower temperature than the surroundings, even a temperature below 0° C. In such a design, the energy content of the working fluid (flue gases) leaving the system will be lower than the energy content of the surroundings, which means that energy has been transferred from the surroundings to the system, as in a heat pump, said system thereby converting this energy into useful energy in the working fluid. Consequently, the system will have a considerably higher degree of utilisation of fuel than any other conventional power production system, including those who make use of humidification of the working fluid and condensation of the flue gases down to a temperature of about 30° C. The low temperature of the working fluid obtained after completed expansion to state 13 can then be used to produce useful cold (Q_{cool}) via an isobaric heating of the working fluid from state 13 to state 1 before the working fluid leaves the system. The system described thus produces three utilities, viz. mechanical work, thermal energy and cold, with a degree of utilisation of fuel that by far exceeds that of conventional gas turbine plants.

For the sake of completeness, a description of the system's liquid cycle will be given. The water condensed from the working fluid in the flue gas condenser FGC, as well as the water conveyed through it, is supplied by means of a pump P1 to the humidification unit HT. The water is, however, conveyed via the economiser ECO, the after-cooler AC and the intermediate cooler IC for pre-heating of the water before the humidification. When the water has passed the humidification unit HT it is conveyed by means of a pump P2 back to the flue gas condenser FGC via a heat exchanger HXH, in which useful thermal energy is transferred from the water to a heat sink, such as a district heating system.

The system may also comprise a control unit CU which is connected to one or more actuators in the system. The control unit CU allows dynamic control of the relative distribution between the amount of mechanical work produced, the amount of heat diverted in the flue gas condenser FGC and the useful cold (Q_{cool}), by controlling the volume of the amount of heat diverted in the flue gas condenser FGC and/or the pressure p₉. The volume of the amount of heat diverted in the flue gas condenser FGC may, for example, be controlled via the flow on the cold side of the heat exchanger HXH, or via any other suitable quantity of the heat sink connected to the heat recovery unit HR. The pressure p₉ in the flue gas condenser FGC can be controlled by means of a control valve through which the flue gases are passing and/or by decelerating the turbine T2.

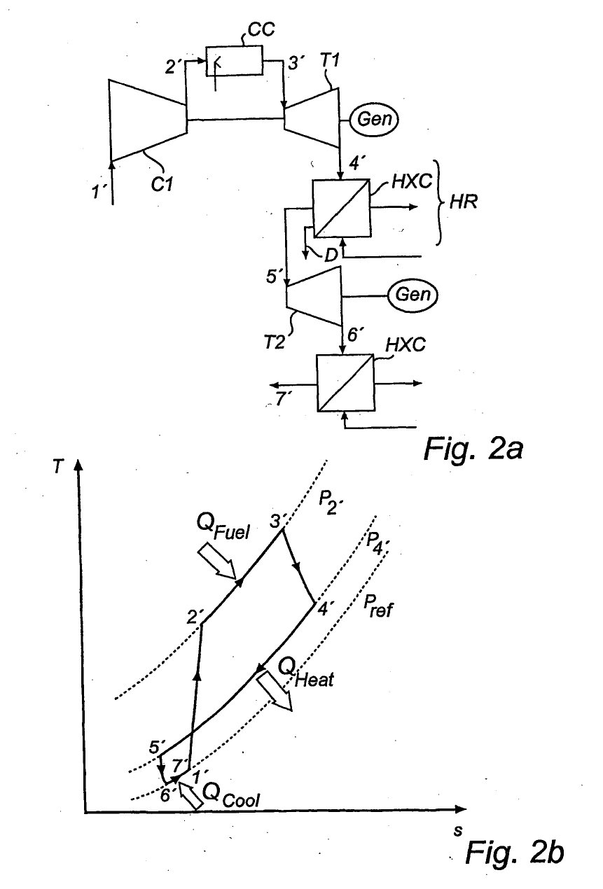

It should be pointed out, however, that many components of the system in FIG. 1, including those indicated by dashed lines, can be omitted. Furthermore, the flue gas condenser FGC and the heat exchanger HXH, as well as the recuperator REC and the economizer ECO, can be replaced by any other heat recovery unit HR, as will be apparent from the following discussion of the alternative embodiments illustrated in FIGS. 2-10. The following description will focus on relevant differences between these embodiments and the system in FIG. 1.

FIG. 2a illustrates a system according to the invention, said system being built around a gas turbine and operating without either internal heat recovery or supply of liquid to the working fluid before the combustion chamber CC. FIG. 2b shows a state digram for the system in FIG. 2a. Components equivalent to those in FIG. 1a have the same reference numerals.

As shown in FIG. 2b, the working fluid is first compressed polytropically from state 1′ to state 2′ in the compressor C1, following which thermal energy (Q_{fuel}) is supplied to the compressed working fluid at pressure p₂ from state 2′ to state 3′ in the combustion chamber CC. This is followed by a polytropic expansion in the turbine T1 from state 3′ to state 4′, corresponding to a change of pressure from p₂ to p₄, said pressure p₄ being higher than atmospheric pressure p_{ref}. During the expansion in the turbine T1, mechanical work is generated. After that, an isobaric diversion of useful thermal energy (Q_{Heat}) from the expanded but still pressurized working fluid takes place between state 4′ and state 5′ in a heat recovery unit HR comprising a surface heat exchanger HXH. If the moisture content of the working fluid is sufficient phase transformation energy can be obtained as well, and a condensate can be diverted from the heat exchanger, as indicated at D. This is followed, as in the system in FIGS. 1a-b, by a second polytropic expansion of the working fluid to atmospheric pressure (p_{ref}) from state 5′ to state 6′ in the turbine T2. Thus, further mechanical work is generated. The low temperature of the working fluid after completed expansion is then used to produce useful cold (Q_{cool}) by isobaric heating of the working fluid from state 6′ to state 7′ in the heat exchanger HXC.

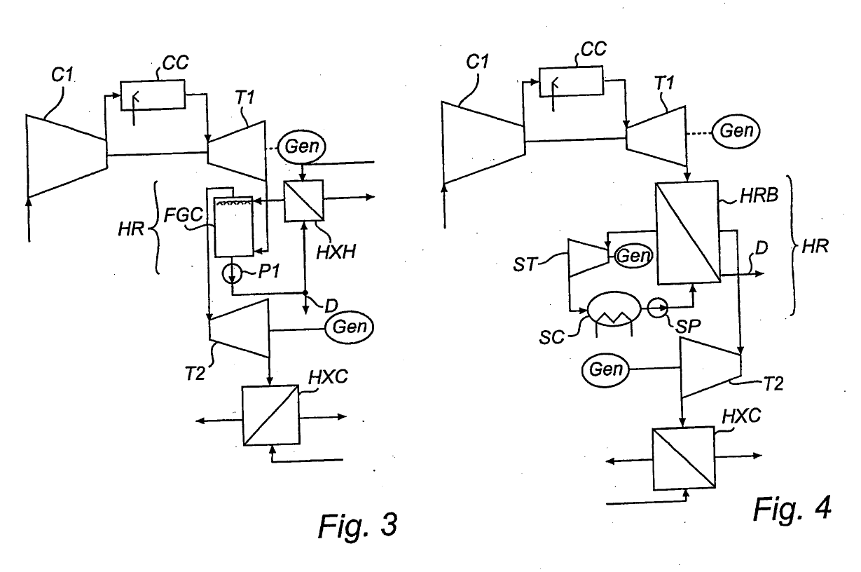

FIG. 3 illustrates a variant of the system in FIG. 2a. A heat recovery unit HR comprising a flue gas condenser FGC, typically a scrubber, is arranged to divert thermal energy from the working fluid at a raised pressure after expansion in the first turbine T1. The liquid diverted from the scrubber FGC is pumped through a heat exchanger HXH for transferring useful thermal energy to an external heat sink. If required, a condensate can be drawn off, as indicated at D. An advantage of the embodiment in FIG. 3 is that the working fluid is purified in the scrubber FGC while at the same time useful thermal energy is diverted. If required, the liquid diverted from the scrubber FGC may be caused to pass a purification device (not shown) before being recirculated to the scrubber FGC.

With reference to FIG. 4, a further variant of the system in FIG. 2a is shown. A heat recovery unit HR comprising a waste heat boiler HRB is arranged to divert thermal energy from the working fluid at a raised pressure after expansion in the first turbine T1. If required, a condensate can be drawn off, as indicated at D. The waste heat boiler HRB then drives a steam turbine. ST for production of electric power. The steam turbine TS forms part of a steam cycle, together with a condenser SC and a pump SP. In this case, the thermal energy diverted is thus supplied to a bottoming cycle for production of further ther power and thermal energy. Consequently, the arrangement in FIG. 4 forms a combined cycle.

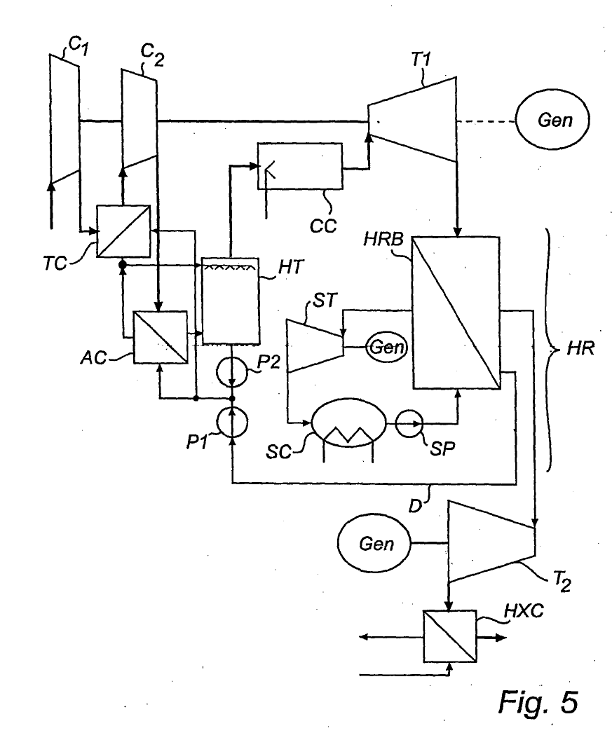

With reference to FIG. 5, a further embodiment of the system according to the invention is shown. The system here comprises a humidification unit HT which is arranged between the compressor step C1, C2 and the combustion chamber CC and which supplies water vapour to the working fluid. The water supplied to the humidification unit HT is preheated in an intermediate cooler IC and an after-cooler AC, as described in connection with FIG. 1a. Further, a heat recovery unit HR comprising a waste heat boiler HRB is arranged to divert thermal energy from the working fluid at a raised pressure after expansion in the first turbine T1. The waste heat boiler HRB then drives a steam turbine ST for production of electric power. As in FIG. 4, the diverted thermal energy is thus supplied to a bottoming cycle for production of additional power. The arrangement, which constitutes a hybrid between a combined cycle and a HAT cycle, is designed to produce power, thermal energy and cold. If required, a condensate can be drawn off from the waste heat boiler HRB, as indicated at D. In this connection, a closed liquid cycle may be formed by recirculating the condensate drawn off to the humidification unit HT, possibly via a purification device (not shown). Once the working fluid has passed the waste heat boiler HRB, it is allowed to expand to atmospheric pressure in the turbine T2 for generation of additional mechanical work. The low temperature of the working fluid after completed expansion is then used to produce useful cold in the heat exchanger HXC.

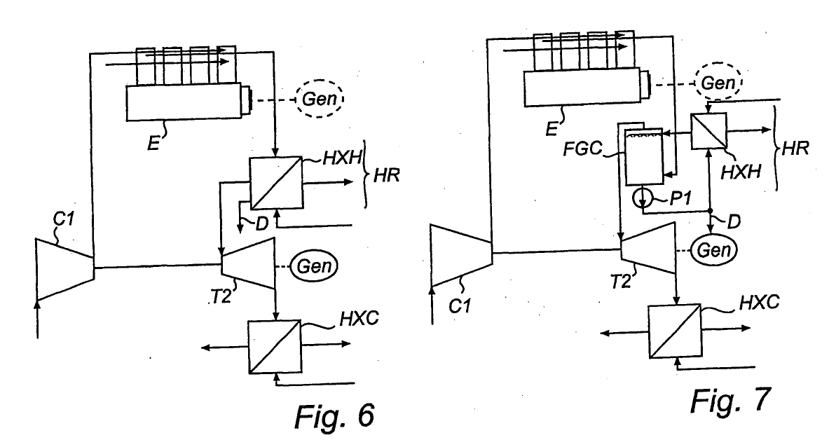

FIGS. 6-9 illustrate different embodiments of the system for power production according to the invention, as built around an internal combustion engine E. Because these embodiments are based on the same principles as the embodiments in FIGS. 1-5, the following description focuses on relevant differences.

In FIG. 6, which corresponds to FIG. 2a, the working fluid is first compressed polytropically in the compressor C1, following which the working fluid is conveyed into the combustion chamber of the engine E, where it is compressed further. The working fluid then absorbs thermal energy (Q_{Fuel}) generated by the combustion of a fuel therein, and is expanded polytropically to a pressure above atmospheric pressure. During the expansion in the engine E, mechanical work is generated and, depending on the application, this work can be converted into useful shaft work, for example for propulsion, or electrical energy, be means of a generator or the like. Useful thermal energy (Q_{Heat}) is then isobarically diverted from the expanded, but still pressurized, working fluid in a heat recovery unit HR comprising a surface heat exchanger HXH. If the moisture content of the working fluid is sufficient, phase transformation energy can be obtained as well, and a condensate can be diverted from the heat exchanger, as indicated at D. This is followed by a second polytropic expansion of the working fluid to atmospheric pressure in a turbine T2, which suitably drives the compressor C1. A possible excess of mechanical work generated can be converted into electric power by means of a generator or the like. After the expansion is completed, the working fluid has a low temperature that is used to produce useful cold (Q_{cool}) by isobaric heating of the working fluid in a heat exchanger HXC.

In FIG. 7, which corresponds to FIG. 3, a variant of the system in FIG. 6 is shown. The heat recovery unit HR here comprises a flue gas condenser FGC, typically a scrubber, which diverts thermal energy from the working fluid at a raised pressure after the expansion in the, internal combustion engine E. For details concerning implementation and advantages, reference is made to the description of FIG. 3.

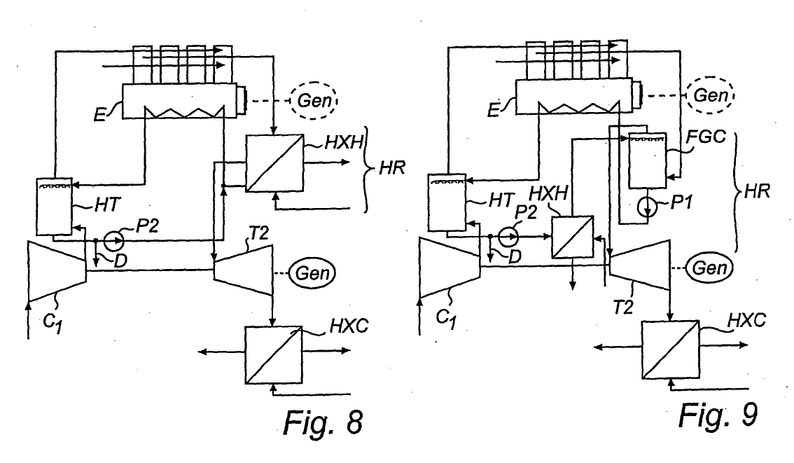

FIG. 8 illustrate a variant in which a humidification unit HT is arranged between the compressor C1 and the internal combustion engine E, said unit supplying water vapour to the working fluid. The arrangement thus forms a HAM cycle. The humidification unit HT, which forms part of a water cycle, provides a condensate which, by means of the pump P2, is recirculated to the humidification unit HT through the engine block for preheating of the condensate. In addition to the advantageous ability to produce three utilities, viz. mechanical work, thermal energy and cold, a further advantage is achieved in that the water which in the humidification unit HT is introduced into the working fluid is recirculated to the water cycle by drawing off condensate from the heat recovery unit HR, in this case a heat exchanger HXH. Thus, no water needs to be supplied to the water cycle. Instead, when burning fuels with a high hydrogen content and/or wet fuels, water needs to be drawn off from the water cycle.

In FIG. 9 a variant of the embodiment in FIG. 8 is shown. A heat recovery unit HR comprising a flue gas condenser FGC, typically a scrubber, is arranged to divert thermal energy from the working fluid at a raised pressure after the expansion in the internal combustion engine E. The hot liquid diverted from the scrubber FGC is fed by means of the pump P1 and through the engine block to the humidification unit HT, optionally via a purification device (not shown). The liquid diverted from the humidification unit HT is pumped back to the flue gas condenser FGC via a heat exchanger HXH, in which useful thermal energy is transferred to an external heat sink. A closed liquid cycle is provided, from which liquid can be drawn off when required, as indicated at D.

It is worth pointing out that the compressor C1 in some cases can be omitted in the systems according to FIGS. 6-9, since the working fluid is compressed to a certain extent by the change of volume of the combustion chamber of the engine E.

It should also be pointed out that the invention is applicable to both stationary and mobile systems for power production. The system according to the invention can be adapted, depending on the application, for optimal purification of the flue gases and/or provision of a given relationship between the amount of mechanical work produced and the amount of thermal energy and/or cold produced. For example, the “useful thermal energy” may be diverted by cooling in a cooling tower or the like in the case where only production of power and cold is of interest. Alternatively, the working fluid can be expanded to atmospheric pressure in throttling or the like, following the diversion of the second amount of heat at the raised pressure, in the case where production of cold and limited production of power with efficient purification of the flue gases is of interest. The efficient purification of the flue gases is carried out by diverting and purifying the condensate formed during expansion in throttling. According to a further alternative, the system can be designed exclusively for production of power and thermal energy, i.e. without utilisation of the low temperature of the flue gases after the final expansion thereof.

It will be appreciated that a system according to the invention can be achieved by means of a new design, but also by conversion of an existing power production plant comprising an internal combustion engine or a gas turbine by installing an assembly for retroactive mounting. Such an assembly for retroactive mounting will comprise at least one heat recovery unit, for example a surface heat exchanger or a scrubber, which is connectable downstream of the internal combustion engine or the gas turbine for diversion of an amount of heat from the working fluid at a pressure above atmospheric pressure. With such a heat recovery unit the flue gases can be purified from water-soluble pollutants and dust present in the condensate that is drawn off from the heat recovery unit. This kind of conversion is particularly straightforward, and desirable, in a turbosupercharged internal combustion engine, in particular a diesel engine, since there is usually space available for the installation of the assembly for retroactive mounting between the engine and the turbo unit. The conversion is also possible in a gas turbine, in particular a turbine with multiple shafts, in which case the assembly for retroactive mounting is connected between some of the turbines of the gas turbine.

In addition, the assembly for retroactive mounting suitably comprises a humidification unit which is connectable to an inlet of the internal combustion engine, or between the compressor and the combustion chamber of the gas turbine, for the purpose of introducing a liquid, preferably water, into the pressurized working fluid. An elevated degree of efficiency, a lowered NOₓ content of the flue gases as well as a closed water cycle are thereby provided.

It should also be pointed out that the above assembly for retroactive mounting allows production of three utilities, viz. mechanical work, thermal energy and cold.

1. A method for power production comprising the successive steps of pressurizing a working fluid containing oxygen, preferably air, supplying a first amount of heat to the working fluid by substantially complete combustion of a fuel in the working fluid, allowing the working fluid to expand for production of mechanical work, diverting a second amount of heat from the thus expanded working fluid at a pressure above atmospheric pressure, and, following the diversion of the second amount of heat, further expanding the working fluid, preferably to atmospheric pressure, preferably for production of additional mechanical work.

2. A method according to claim 1, comprising the step of causing the working fluid to absorb, following said further expansion, a third amount of heat from a cooling fluid, for cooling of the same.

3. A method according to claim 1 or 2, wherein the second amount of heat is at least partially transferred to an external heat sink, such as a district-heating system or a cooling tower, in connection with the diversion.

4. A method according to claim 1, 2 or 3, comprising the step of introducing a liquid, preferably water, into the working fluid before the first amount of heat is supplied to it by the combustion.

5. A method according to any one of claims 1-4, wherein part of the working fluid forms a condensate in connection with the diversion of the second amount of heat.

6. A method according to claim 5, wherein the condensate is diverted from the working fluid via a purification device.

7. A method according to claim 5 or 6, wherein the condensate is at least partially recirculated to the working fluid before this is allowed to expand for production of mechanical work.

8. A method according to claim 7, wherein the condensate is heated before it is recirculated to the working fluid, preferably at least partially by the condensate being caused to absorb part of the second amount of heat.

9. A method according to any one of the preceding claims, comprising the step of controlling the relation between the amount of mechanical work produced, the second amount of heat, and, where appropriate, the third amount of heat, by controlling the volume of the second amount of heat and/or said pressure.

10. A system for power production comprising a compression unit (C1, C2; C1, E) for pressurizing a working fluid containing oxygen, preferably air, a combustion unit (CC; E) which downstream of the compression unit (C1, C2; C1, E), as seen in the direction of flow of the working fluid, is arranged to supply a first amount of heat to the working fluid by substantially complete combustion of a fuel in the working fluid, an expansion unit (T1; E) which is arranged to produce mechanical work during expansion of the working fluid, and a heat recovery unit (HR) which downstream of the expansion unit (T1; E) is arranged to divert a second amount of heat from the working fluid at a pressure above atmospheric pressure, and a secondary expansion unit (T2), which is arranged to receive the working fluid from the heat recovery unit (HR) and to further expand the working fluid, preferably to atmospheric pressure, preferably for production of additional mechanical work.

11. A system according to claim 10, further comprising a cooling unit (HXC), which is arranged to receive the working fluid from the secondary expansion unit (T2) and to transfer a third amount of heat from a cooling fluid to the working fluid.

12. A system according to claim 10 or 11, wherein the heat recovery unit (HR) comprises a heat exchanger (HXH), which is arranged to divert at least partially the second amount of heat from the working fluid, preferably to an external heat sink, such as a district-heating system or a cooling tower.

13. A system according to claim 10, 11 or 12, wherein the heat recovery unit (HR) comprises a scrubber (FGC), which is arranged to purify the working fluid and divert at least partially the second amount of heat from the working fluid, preferably to an external heat sink, such as a district-heating system.

14. A system according to any one of claims 10-13, wherein the heat recovery unit (HR) comprises a waste heat boiler (HRB), which is arranged to divert at least partially the second amount of heat from the working fluid for production of additional mechanical work, preferably by driving at least one steam turbine (ST).

15. A system according to any one of claims 10-14, wherein the heat recovery unit (HR) is arranged to cause at least partially the working fluid to condense in connection with the diversion of the second amount of heat so as to form a condensate.

16. A system according to any one of claims 10-15, further comprising a humidification unit (HT), which is arranged to introduce, in connection with the combustion unit (CC; E), a liquid, preferably water, into the preferably pressurized working fluid.

17. A system according to claims 15 and 16, wherein the heat recovery unit (HR) is connected to the humidification unit (HT) for recirculation of at least part of the condensate to the working fluid, preferably via one or more heating units (IC, AC, ECO).

18. A system according to any one of claims 10-17, wherein at least the compression unit (C1, C2), the combustion unit (CC) and the expansion unit (T1) form part of a gas turbine plant.

19. A system according to any one of claims 10-17, wherein the combustion unit and at least part of the expansion unit form part of an internal combustion engine (E), which is arranged to generate useful shaft power, and wherein the compression unit (C1) is preferably driven by means of at least one turbine (T2) located downstream of the heat recovery unit (HR) and passed by the working fluid.

20. A system according to claim 19, wherein the internal combustion engine (E) is arranged to drive a generator for conversion of the shaft work generated by the internal combustion engine (E) into electric power.

21. An assembly for retroactive mounting in a system for power production, said system comprising an internal combustion engine (E) which is arranged to pressurize a working fluid containing oxygen, to supply a first amount of heat to the working fluid by combustion of a fuel in the working fluid and to produce mechanical work during expansion of said working fluid, said assembly comprising a heat recovery unit (HR) which is connectable downstream of the internal combustion engine (E) for diversion of a second amount of heat from the working fluid at a pressure above atmospheric pressure and which is connectable to at least one turbine (T2), said turbine (T2) being arranged to drive at least one compressor (C1) arranged upstream of the internal combustion engine (E) through further expansion of the working fluid.

22. An assembly according to claim 21, further comprising a humidification unit (HT) which is connectable to an inlet of the internal combustion engine (E) for the purpose of introducing a liquid, preferably water, into the preferably pressurized working fluid.

23. An assembly according to claim 22, wherein the heat recovery unit (HR) is designed to cause at least partially the working fluid to condense in connection with the diversion of the second amount of heat so as to form a condensate, and wherein the humidification unit (HR) is connected to the heat recovery unit (HR) for reception of at least part of the condensate, preferably via one or more heating units.

24. An assembly according to any one of claims 21-23, wherein the heat recovery unit (HR) comprises a scrubber (FGC), which is arranged to purify the working fluid and at least partially divert the second amount of heat from the working fluid.

25. An assembly for retroactive mounting in a system for power production, said system comprising at least one compressor (C1, C2) which is arranged to pressurize a working fluid containing oxygen, at least one combustion chamber (CC) which is arranged downstream of said at least one compressor (C1, C2) to supply a first amount of heat to the working fluid by combustion of a fuel in the working fluid, at least one first and one second turbine (T1, T2) which are arranged downstream of said at least one combustion chamber (CC) for production of mechanical, work through expansion of the working fluid, said assembly comprising a heat recovery unit (HR) which is connectable downstream of said at least one first turbine (T1) and upstream of said at least one second turbine (T2) for diversion of a second amount of heat from the working fluid at a pressure above atmospheric pressure.

26. An assembly according to claim 25, further comprising a humidification unit (HT) which is connectable between said at least one compressor (C1, C2) and said at least one combustion chamber (CC), for the purpose of introducing a liquid, preferably water, into the working fluid.

27. An assembly according to claim 26, wherein the heat recovery unit (HR) is designed to cause at least partially the working fluid to condense in connection with the diversion of the second amount of heat so as to form a condensate, and wherein the humidification unit (HR) is connected to the heat recovery unit (HR) for reception of at least part of the condensate, preferably via one or more heating units.

28. An assembly according to any one of claims 25-27, wherein the heat recovery unit (HR) comprises a scrubber (FGC), which is arranged to purify the working fluid and at least partially divert the second amount of heat from the working fluid.
